(19) United States
(12) Patent Application Publication
(10) Pub. No.: US 2023/0232920 A1
(43) Pub. Date: Jul. 27, 2023

(54) Elastic Layered Air Chamber Creating Insulating Fabric and Method of Manufacture and Use

(71) Applicants: Therese Michelle Jalbuena Paman, Paranaque City (PH); James Junor Castillio Maganar, Cagayan de Oro (PH)

(72) Inventors: Therese Michelle Jalbuena Paman, Paranaque City (PH); James Junor Castillio Maganar, Cagayan de Oro (PH)

(73) Assignee: Fownes Brothers and Co. INC., New York, NY (US)

(21) Appl. No.: 17/733,223

(22) Filed: Apr. 29, 2022

Related U.S. Application Data
(60) Provisional application No. 63/302,598, filed on Jan. 25, 2022.

(51) Int. Cl. A41D 19/00; A41D 31/06; A41D 31/18

(52) U.S. Cl. CPC A41D 19/0044; A41D 31/06; A41D 31/18

(57) ABSTRACT

An elastic layered air chamber creating insulating fabric for clothing and method of manufacture and use thereof consisting of an elastic fabric stretchable base layer in a stretched state to the top of which is attached by seams, a second fabric layer of lesser elasticity in a selected pattern resulting in an array of raised portions on the upper surface of the second fabric when the base layer is relaxed, such raised portions creating insulating air pockets when brought into contact with human skin

### CROSS REFERENCE TO RELATED APPLICATIONS

This application is based on the disclosure of U.S. Provisional Application No. 63/302,598 filed Jan. 25, 2022 by the same inventors which disclosure is herein incorporated by reference.

### BACKGROUND OF THE INVENTION

Field of the invention: The invention resides in the field of multilayered insulating fabric structures and more particularly relates to their use in the manufacture of clothing Description of the prior art: Insulating fabric materials are well known for their use in gloves suitable for cold weather outdoor activities, such as snowboarding, skiing, and hiking. Conventional winter gloves or hand coverings typically include fastening devices such as hook and loop combinations, zippers, buckled straps, or elastic bands to secure a glove cuff around a wrist. The present invention employs various layers of both elasticized stretchable and non-stretchable fabrics combined by a unique manufacturing process to provide both insulting air chambers and elastic wraps for clothing, particularly for gloves and outerwear sleeve cuffs. No prior art disclosing the invention described herein is known to the inventors.

### SUMMARY OF THE INVENTION

The invention is an elastic layered air chamber creating insulating fabric and method of manufacture which may be employed, as an example, to contract the entry and cuff of a glove or mitten opening around the wrist of the wearer to improve fit, to minimize internal heat loss, and prevent cold and elements from entering through the opening while the glove is worn.

In a glove, an internal lining cuff is created from at least two layers. The internal layer, the layer adjacent to the shell of the glove, must be stretchable. All other layers may be a flexible stretch or non-stretch fabric. The cuff construction may or may not contain additional fabric insulation.

The fabric is created using a sewing frame over which a portion of stretchable fabric comprising a base layer is stretched to expand its outer parameter. A second layer of either stretchable fabric less stretchable than the first layer or non-stretchable is placed over the first layer. The two layers are then joined achieved by sewing, or through similar methods such as ultrasonic joining, together in a series of spaced apart seams of a selected pattern, parallel seams, for example. This creates a plurality of isolated multi-layered fabric cells which, when the assembly is removed from the frame, will bunch up the second layer by relaxing the first layer to provide a second layer surface consisting of micro hills and valleys.

In the use of this insulating material, in a glove liner for example, the first layer is positioned against the interior of the glove, and the second layer, when the glove is worn, against the skin of the wearer providing the insulating air pockets of the invention.

This construction and placement of the closure is made in conjunction with the glove or mitten lining and does not alter the appearance of the exterior portion of the glove or mitten as do other means of cuff and opening closures. While there have long been knitted cuffs, straps, shock cord hems, elasticized wrists and other means to tighten the wrist area of a hand covering, the current invention creates air chambers on the cuff lining, allowing the hand to be easily inserted into the hand covering and encase the wearers wrist and lower arm area, no matter the size, to hold in warm air around the hand and minimize cold air, snow, and moisture from entering the glove. Additionally these internal cuff chambers hold warm air against the wears skin, and thereby create a warmer cuff environment.

The chambered cuff lining construction may be a continuous cylinder, completely encasing the wrist of the wearer. Alternatively, the chambered cuff lining construction may be discontinuous, encasing only a portion or selected portions of the wrist.

The chambered cuff lining construction may begin at the glove or mitten opening, and may extend the full length of the wrist to the heel of the palm or cover only a segment of the wrist. The chambered cuff construction will not extend beyond the base of the thumb on the palm side of the hand, and not beyond the knuckles on the back of hand.

The chambered cuff lining construction may or may not be applied in conjunction with external fasteners to improve and enhance the function of the hand covering.

### DESCRIPTION OF THE FIGURES

FIG. 1 is a schematic diagram of the manufacturing process of the fabric of the invention;

FIG. 2 is an illustration of a sewing assembly frame referenced in FIG. 1;

FIG. 3A is a perspective view of a structure relating to the invention;

FIG. 3B is a top view of the structure of FIG. 3A; and

FIG. 3C is a cross-sectional view of the structure of FIG. 3A along line 3C-3C of FIG. 3B;

FIG. 4A is an additional drawing of a structure relating to the invention;

FIG. 4B is another additional drawing of a structure relating to the invention; and

FIG. 4C is a cross-sectional drawing of the structure of FIG. 4B along line 4C-4C.

### DESCRIPTION OF THE PREFERRED EMBODIMENT

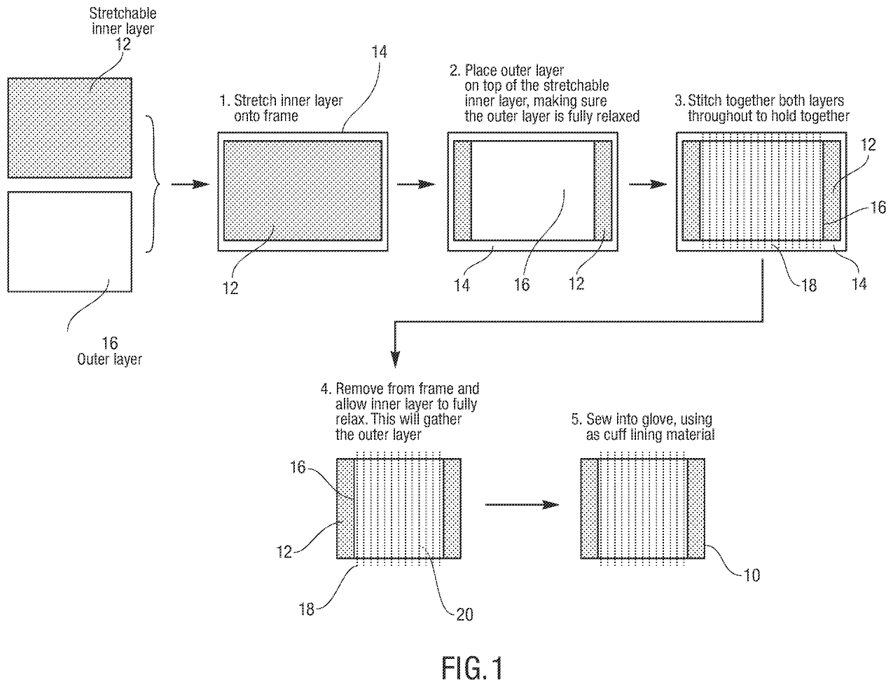

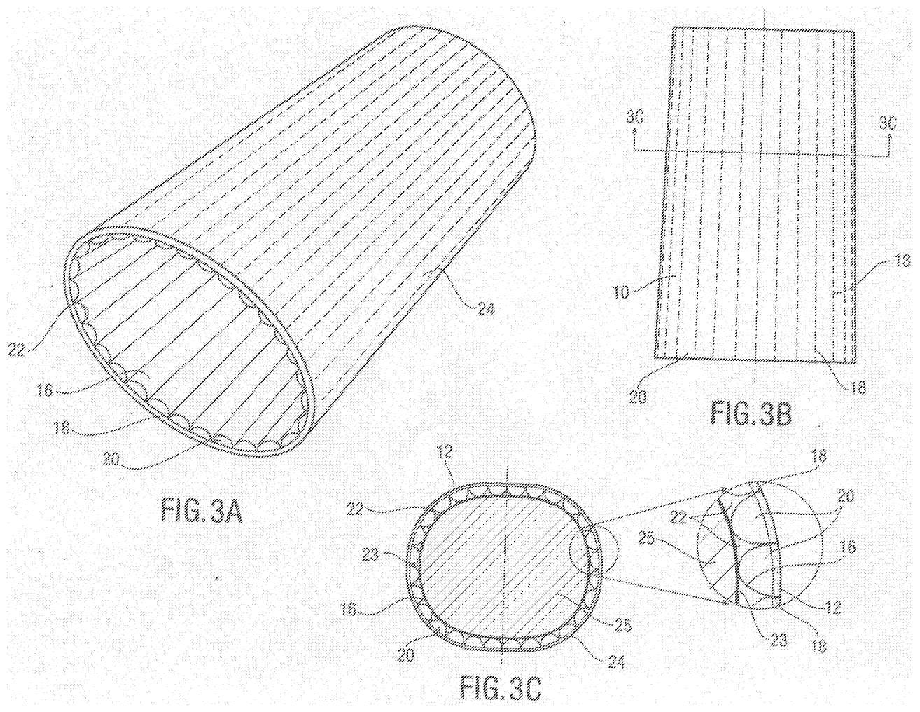

Referring to FIG. 1, the steps required to create the novel composite material 10 of the invention are shown and described in which an elasticized stretchable inner fabric layer 12, a Spandex-polyester composite for example, is secured in a stretched state on frame 14, step 1, over which is then placed a second outer layer of fabric material 16, step 2, which is either non-stretchable or less stretchable than the inner layer 12, taffeta for example, and is suitable for direct contact with the skin of a hand or wrist. Fabric layer 16 is then joined to layer 12, step 3, by parallel rows of spaced apart seams, by, for example, sewn stitches 18, in a parallel array, which, when the composite is released from the frame, step 4, will cause the segments 20 of sheet 16 to pucker or gather and form insulating air pockets 22 when in contact with the skin 23 of a wrist 25 as shown in FIG. 3C. Additionally, it should be understood that layer 16 may itself consist of more than one fabric bonded together to provide, for example, more insulation or strength to the finished composite.

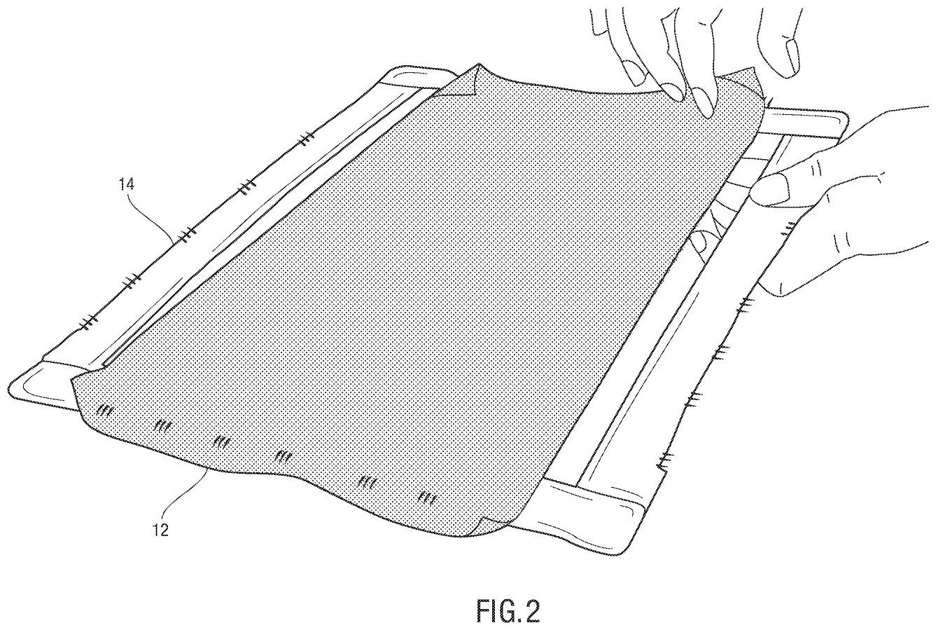

FIG. 2 shows a frame 14 with a stretchable inner layer 12 in stretched condition secured thereon, step 1, of FIG. 1.

FIGS. 3A, 3B, and 3C illustrate a cuff assembly 24 constructed from a sheet of composite material 10 as created by steps 1, 2, 3, and 4 of FIG. 1 and the components of which are as described above.

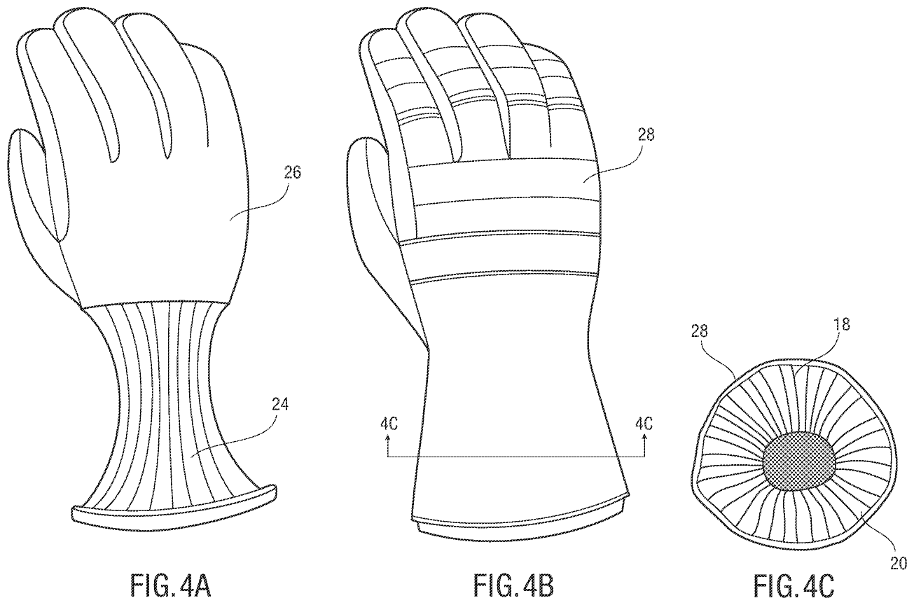

FIG. 4A shows a cuff assembly 24 as employed in the manufacture of a glove lining 26 which is then, as is shown in FIGS. 4B and 4C, combined with an outer shell 28 to produce a finished wrist form fitting insulating glove. The materials of the invention used in the production of the glove lining cuff are:

the inner layer 12 next to the shell on the finished product is composed of 87% polyester and 13% spandex available from IGD Industries, Taipei, Taiwan;

the outer layer 16 against the wearers body is composed of 100% polyester taffeta made by Formosa Taffeta, Ho Chi Minh City, Vietnam; or 93% polyester and 7% spandex micro-fleece made by Ducksan Fabrics, Seoul, Korea; and

an optional Insulation layer, bonded as part of the outer layer, when used, is composed of Knitted 75% wool, 25% nylon made by Ruiqing Knits, Inc., Shanghai, China.

While the use of the cloth is described in detail as applied to a glove, it will be seen that it may be advantageously employed in the manufacture of other articles of clothing such as head bands, scarfs, slippers, neck gaiters and the like.

Accordingly, the scope of the invention described above is hereby defined by the following claims.

What is claimed is:

1.-5. (canceled)

6. A method of manufacturing an elasticized layered air chamber-creating insulating fabric for clothing comprising in combination the steps of:
A. providing a first base layer of elasticized stretchable fabric having a top and bottom surface;
B. providing a second layer of fabric of an elasticity less than that of said first elastic layer;
C. providing a frame for attaching said first and second layers to one another;
D. stretching said first layer of fabric over said frame to expand the parameter of said layer;
E. placing said second layer of fabric over said top surface of said first layer; and
F. attaching said second layer to said top surface of said first layer by seams in a selected pattern, said pattern defining a plurality of ancillary cells, each of said cells creating in combination when said first layer is relaxed a surface array of spaced apart, raised adjacent portions of said second layer above said first layer top surface, said raised portions creating in combination a plurality of insulating air chambers when in contact with human skin.

7. The insulating fabric of claim 6 wherein said seams are created by sewing.

8. The insulating fabric of claim 6 wherein said seams are created by ultrasonic joining.

9. The insulating fabric of claim 6 wherein said second layer is a bonded composite of at least two fabrics, one of which comprises an insulation fabric.

10. The insulating fabric of claim 6 wherein said clothing comprises a glove cuff.

11.-16. (canceled)

17. An elastic layered discrete air chamber—creating stretchable insulating fabric for stretchable components of clothing comprising:
A. a first base layer composed of an elasticized stretchable insulating sheet of fabric having a top surface and a bottom surface; and
B. a second layer comprising a gatherable insulating sheet of fabric of an elasticity less than that of said first base layer joined to said top surface of said first base layer in a selected pattern of seams, said pattern defining a plurality of ancillary cells, each of said cells creating in combination a surface array of spaced apart, raised adjacent portions of said second gatherable layer sheet of fabric above said top surface of said first base layer, said raised portions creating in combination a plurality of discrete insulating air chambers when in contact with a human body component.

18. The insulating fabric of claim 17 wherein said seams are created by sewing.

19. The insulating fabric of claim 17 wherein said seams are created by ultrasonic joining.

20. The insulating fabric of claim 17 said second layer comprising a gatherable sheet of fabric is a bonded composite of at least two fabrics, one of which comprises an insulation fabric.

21. The insulating fabric of claim 17 wherein said stretchable component of clothing comprises a glove cuff.

22. The insulating fabric of claim 17 wherein said stretchable component of clothing comprises an outerwear sleeve cuff.
